(19) United States
(12) Patent Application Publication
(10) Pub. No.: US 2025/0214354 A1
(43) Pub. Date: Jul. 3, 2025

(54) RECORDING DEVICE

(71) Applicant: SEIKO EPSON CORPORATION, Tokyo (JP)

(72) Inventors: Fusao OHASHI, SHIOJIRI-SHI (JP); Yuki AOKI, SHIOJIRI-SHI (JP); Naohiro UEYAMA, MATSUMOTO-SHI (JP)

(21) Appl. No.: 19/001,721

(22) Filed: Dec. 26, 2024

(30) Foreign Application Priority Data
Dec. 29, 2023 (JP) 2023-223787

(51) Int. Cl. B41J 11/00; B41J 3/407

(52) U.S. Cl. CPC B41J 11/0022; B41J 3/4078

(57) ABSTRACT

It includes a recording section 5 configured to record an image on the medium transported by a transport section 4; a heating section 6 that heats the medium that was recorded on and that is transported in the first direction D1; and a downstream transport path member 7 that constitutes a transport path at a position downstream of the heating section, wherein the downstream transport path member is arranged at a position overlapping the heating section in a plan view from the first direction, the heating section has an air flow path body 8, a heater 9, an air inlet port 10 for sucking air into the air flow path body, an air outlet port 11 for blowing air to the outside of the air flow path body, and a fan 12 for sending air from the air inlet port to the air outlet port, and the air inlet port 10is arranged on a side of the air flow path body 8 in the second direction D2 intersecting with the first direction D1 of the air flow path body 8 and on a side opposite to the side facing the medium.

The present application is based on, and claims priority from JP Application Serial Number 2023-223787, filed Dec. 29, 2023, the disclosure of which is hereby incorporated by reference herein in its entirety.

### BACKGROUND

### 1. Technical Field

The present disclosure relates to a recording device.

### 2. Related Art

An example of this type of device is the heating device and medium handling device described in JP-A-2019-107822. JP-A-2019-107822 shows the following.

A heating device 40 includes a heating section 41 for heating the medium 99, a housing 42 that houses the heating section 41, a flow path 43 through which gas flows, and a blower 44 for blowing gas. The flow path 43 has an inflow port 53 for taking gas into the flow path 43 and an air outlet port 54 for blowing out the gas in the flow path 43. The inflow port 53 and the air outlet port 54 are opened toward a support surface 23. Since the gas inside the apparatus heated by the heating section 41 flows along the support surface 23 to the side opposite to the side on which a recording section 15 is positioned, it is possible to reduce the concern that the heated gas will flow toward the recording section 15.

Although the heater path is inclined in the above-described related art, sometimes the heater path is made vertical in order to reduce the size of the apparatus. Also, sometimes the winding position of the winding section is positioned on the front side to allow a user to easily access the wound up medium.

With such an arrangement, the heated air remains around the lower side of the heater and the upper side of the winding section. In the above-described related art, since the inflow port is opened toward the support surface, that is, in the direction of the medium, the air that remained flows into the heater. Therefore, it is difficult to take fresh air from the outside into the interior of the heater, and the ability to suppress the temperature rise of the surface of the heater exterior and the drying property of the medium deteriorate.

### SUMMARY

To solve the above-described problems, the recording device according to the present disclosure includes a transport section configured to transport a medium in a transport direction of a transport path; a recording section that records an image on the medium transported by the transport section; a heating section that heats the medium that was recorded on and that is transported in a first direction in the transport direction, and a downstream transport path member that constitutes the transport path at a position downstream of the heating section in the transport direction, wherein the downstream transport path member is disposed at a position overlapping the heating section in a plan view from the first direction, the heating section has an air flow path body, a heater that is arranged outside the air flow path body and that is configured to heat the medium, an air inlet port for sucking air from outside the air flow path body into the interior of the air flow path body, an air outlet port for blowing out air that is inside the air flow path body toward the medium, which is outside the air flow path body, and a fan that is arranged inside the air flow path body and that sends air from the air inlet port to the air outlet port, and the air inlet port is provided at a location of the air flow path body that is, with respect to a second direction intersecting the first direction, on a side opposite to a side facing the medium.

### BRIEF DESCRIPTION OF THE DRAWINGS

FIG. 1 is an overall perspective view of a recording device according to a first embodiment.

FIG. 2 is a schematic side view of the first embodiment.

FIG. 3 is an enlarged side sectional view of the heating section of the first embodiment.

FIG. 4 is a perspective view of main section of each a fan and a wall section according to the first embodiment.

FIG. 5 is a perspective view of a main section of an air outlet port of a heating section of the first embodiment.

### DESCRIPTION OF EMBODIMENTS

Hereinafter, the present disclosure will be briefly described.

A first aspect of the recording device according to the present disclosure includes a transport section configured to transport a medium in a transport direction of a transport path; a recording section that records an image on the medium transported by the transport section; a heating section that heats the medium that was recorded on and that is transported in a first direction in the transport direction, and a downstream transport path member that constitutes the transport path at a position downstream of the heating section in the transport direction. The downstream transport path member is disposed at a position overlapping the heating section in a plan view from the first direction, the heating section has an air flow path body, a heater that is arranged outside the air flow path body and that is configured to heat the medium, an air inlet port for sucking air from outside the air flow path body into the interior of the air flow path body, an air outlet port for blowing out air that is inside the air flow path body toward the medium, which is outside the air flow path body, and a fan arranged inside the air flow path body and sends air from the air inlet port to the air outlet port. the air inlet port is provided at a location of the air flow path body that is, with respect to a second direction intersecting the first direction, on a side opposite to a side facing the medium.

According to the present aspect, the air inlet port is provided at a location of the air flow path body that is, with respect to a second direction intersecting the first direction, on a side opposite to a side facing the medium. By this, the downstream transport path member is arranged at a position downstream of the heating section in the transport direction, but the air inlet port is positioned away from the downstream transport path member. In other words, the air inlet port can take fresh air into the inside of the air flow path body from a space separate from a space in which the heated air stagnating in the vicinity of the downstream transport path member exists. Therefore, it is possible to suppress a decrease in the drying properties of the medium. It is possible to suppress the temperature rise of the surface of the air flow path body.

A second aspect of the recording device according to the present disclosure is an aspect according to the first aspect, wherein the air flow path body includes the first flow path body that extends in the first direction and that has the air inlet port and a second flow path body that is coupled to an upstream end section of the first flow path body in the transport direction, that extends in the second direction, and that includes the air outlet port and the heater is arranged at a portion facing both the first flow path body and the second flow path body.

According to the present aspect, the heater is arranged at a portion facing both the first flow path body and the second flow path body. In other words, the heating section, which is composed of the heater and the air flow path body, is arranged such that the heater and the second flow path body are overlapped when viewed from the first direction. By this, an increase in the overall thickness of the heating section can be suppressed.

A third aspect of the recording device according to the present disclosure is an aspect according to the second aspect, wherein the fan is arranged in a region inside the second flow path body and inside the first flow path body.

According to the present aspect, the fan is arranged in a region inside the second flow path body and inside the first flow path body. In other words, the fan is arranged across both regions of the first flow path body and the second flow path body. By this, even when the fan has a size that cannot be arranged inside the first flow path body, a part of the fan is arranged in the region of the second flow path body, and thus it is possible to suppress an increase in size of the entire heating section.

A fourth aspect of the recording device according to the present disclosure is an aspect according to the second aspect, wherein the air inlet port is provided at a position of the end section of the first flow path body on the opposite side of the second flow path body.

The present aspect may be according to the third aspect.

By the present aspect, the air inlet port is provided at a position of the end section of the first flow path body on the opposite side of the second flow path body. By this, fresh air from the outside is sucked in from the air inlet port at the position, flows through the entire length of the first flow path body, and reaches the inside of the second flow path body. Then, the air flows through the second flow path body and is blown out from the air outlet port. Therefore, since the first flow path body and the second flow path body are in contact with the external fresh air, the temperature rise of the entire surface of the air flow path body can be efficiently suppressed.

Since a large distance can be secured between the air inlet port and the fan, it is possible to reduce suction loss due to large bending of the portion serving as the air inlet portion of external air.

A fifth aspect of the recording device according to the present disclosure is an aspect according to the third aspect, wherein the direction in which the fan sends air is different from the direction in which air is blown out from the air outlet port, a wall section is arranged at the region between the fan and the air outlet port, and the wall section guides the direction of air sent from the fan toward the position at which the air outlet port is disposed.

According to the present aspect, the wall section is provided between the fan and the air outlet port, and the wall section guides the direction of the air sent from the fan toward the position at which the air outlet port is arranged. By this, even when the direction in which the fan sends air and the direction in which air is blown out from the air outlet port are different from each other, the air sent out from the fan first hits the wall section, and thus the air can be guided to the air outlet port while being spread in the width direction intersecting the transport direction by the wall section.

A sixth aspect of the recording device according to the present disclosure is an aspect according to the fifth aspect, wherein plural air outlet ports are arranged in a width direction intersecting the transport direction of the transport path.

According to the present aspect, since plural air outlet ports are arranged in a width direction intersecting the transport direction of the transport path., it is possible to blow air uniformly in the width direction.

A seventh aspect of the recording device according to the present disclosure is an aspect according to the first aspect, wherein the first direction is a vertical direction.

The present aspect may be according to any one of the second aspect to the sixth aspect.

In the present aspect, since the first direction is the vertical direction, it is possible to suppress the size of the recording device in the front-rear direction.

### EMBODIMENT

Hereinafter, an embodiment of the recording device

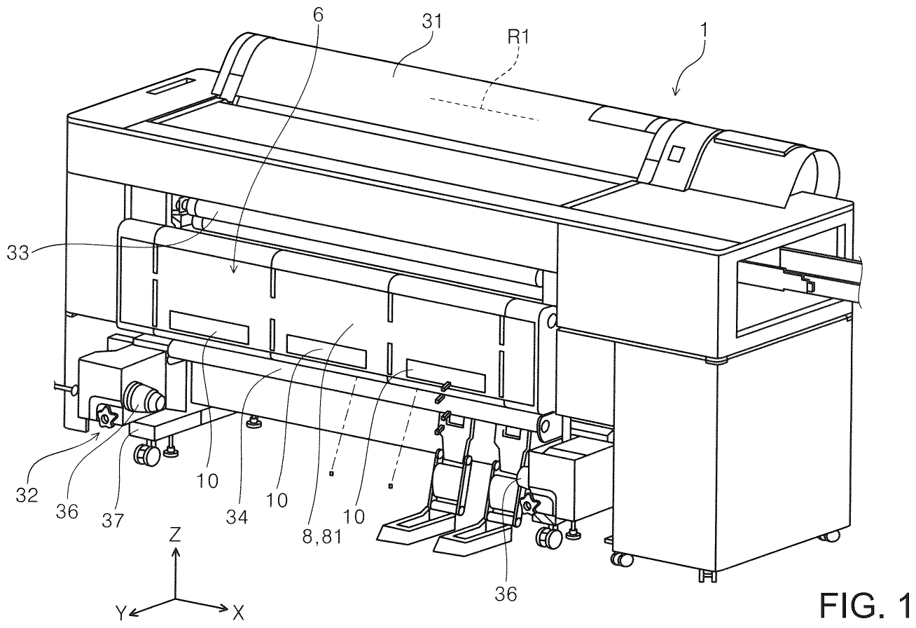

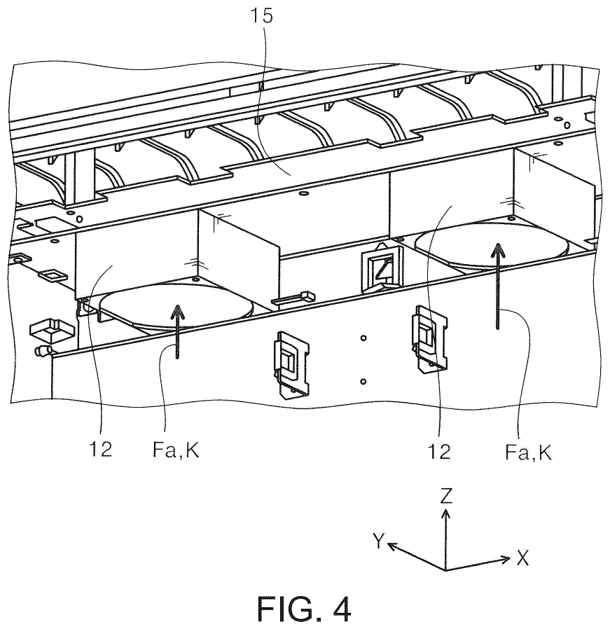

according to the present disclosure will be described with reference to FIGS. 1 to 5.

In the following description, three axes orthogonal to each other are referred to as an X-axis, a Y-axis, and a Z-axis, respectively, as shown in the drawings. The direction indicated by the arrows of the three axes (X, Y, Z) is the +direction of each direction, and the opposite direction is the −direction. The Z-axis direction corresponds to a vertical direction, that is, a direction in which gravity acts, a +Z direction indicates a vertically upward direction, and a −Z direction indicates a vertically downward direction. The X-axis direction and the Y-axis direction correspond to a horizontal direction. The +Y direction indicates the front direction of the recording device, and the-Y direction indicates the rear direction of the device. The +X direction indicates a right direction of the device, and the-X direction indicates a left direction of the device.

### First Embodiment

The recording device of the first embodiment is referred to as a digital textile printing machine in which the medium is a fabric. In this recording device, an appropriate tension is applied to the fabric by a transport method referred to as a roll to reel transport method so that the recording area is floated. The medium that was recorded on and that is heated and dried by the heating section arranged at the transport path and is wound by the winding section.

Hereinafter, the recording device of the present embodiment will be specifically described.

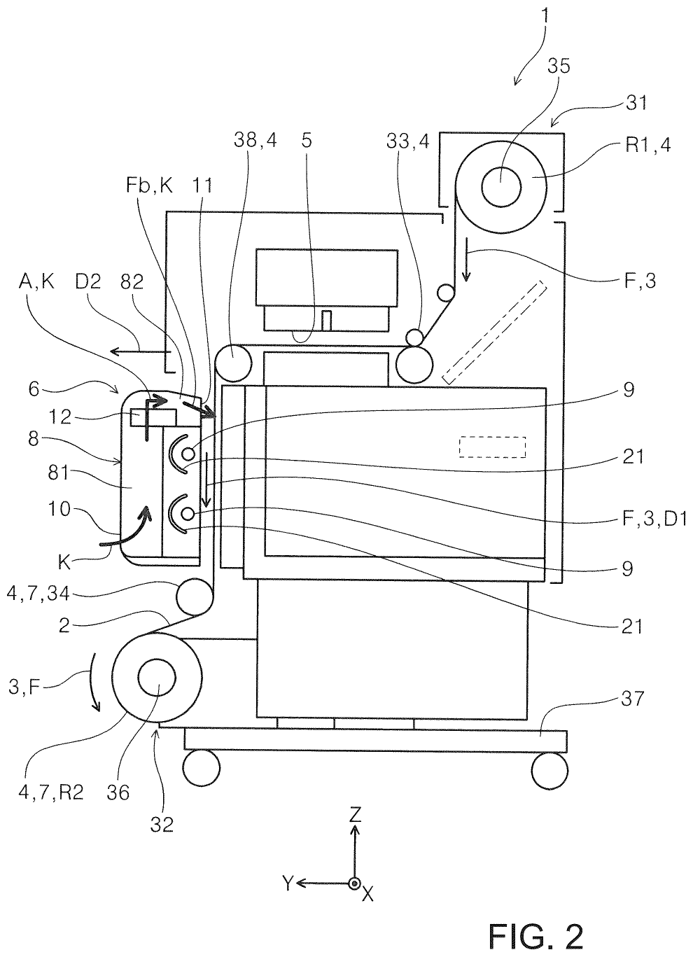

As illustrated in FIGS. 1 to 5, a recording device 1 according to the present embodiment includes a transport section 4 that transports a medium 2 such as fabric in a transport direction F of a transport path 3, a recording section 5 that records an image on the medium 2 transported by the transport section 4, and a heating section 6 that heats the medium 2 that was recorded on and that is transported in first direction D1 in the transport direction F. As shown in FIG. 2, in the present embodiment, the first direction D1 is the vertical direction (−Z direction).

At a position downstream of the heating section 6 in the transport direction F, a downstream transport path member 7 constituting the transport path 3 at a position on the downstream side is arranged. As shown in FIG. 2, the downstream transport path member 7 is arranged at a position overlapping the heating section 6 in a plan view from the first direction D1.

As shown in FIG. 2, the heating section 6 includes an air flow path body 8 and a heater 9. The heater 9 is arranged outside the air flow path body 8. The heater 9 is rod-shaped and provided with a reflecting plate 21 and a wire mesh 22. The air flow path body 8 includes an air inlet port 10 (shown in FIGS. 1 and 2) for taking outside air into the air flow path body 8, and an air outlet port 11 for blowing out the air inside the air flow path body 8 toward the medium 2 outside the air flow path body 8. Further, a fan 12 is arranged inside the air flow path body 8, and the fan 12 sends air from the air inlet port 10 to the air outlet port 11. In other words, the fan 12 creates an air flow from the air inlet port 10 to the air outlet port 11. The reference numeral K indicates the arrow of the flow direction of the air.

The air inlet port 10 is provided in a portion of the air flow path body 8 that is on the side (+Y side) opposite, with respect to the second direction D2 intersecting the first direction D1, to the side (−Y side) facing the medium 2 being transported in the first direction D1.

Transport Path, Transport Section, and Downstream Transport Path Member

As shown in FIG. 2, in the present embodiment, the roll body R1 of the medium 2 is rotatably supported by a feeding shaft 35 of a feeding section 31. The medium 2 drawn from the roll body R1 is transported in the recording range of the recording section 5 by an intermediate roller 33 and an intermediate roller 38 constituting the transport path 3. Further, it is transported in the heating range of the heating section 6 by the intermediate roller 38 and a guide bar 34. The medium 2 passing by the guide bar 34 is wound around the roll body R2 supported by a winding shaft 36 of a winding section 32. The winding shaft 36 is driven and rotated by a rotational power transmitted from a drive source (not shown), causing the roll body R2 to rotate in the winding direction.

In the present embodiment, the transport section 4 includes the roll body R2 of the winding section 32, the guide bar 34, the intermediate roller 38, the intermediate roller 33, and roll body R1 of the feeding section 31. The downstream transport path member 7 includes the guide bar 34 and also the winding section 32 arranged downstream of the heating section 6 in the transport direction F.

### Air Flow Path Body

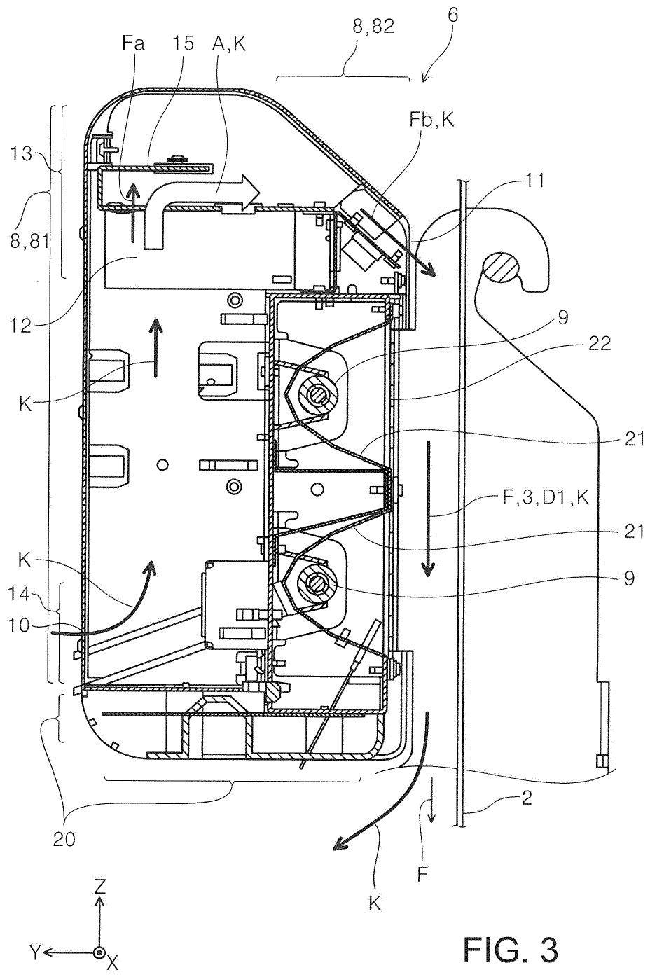

As shown in the enlarged view of FIG. 3, in the present embodiment, the air flow path body 8 has a first flow path body 81 and a second flow path body 82. The first flow path body 81 extends along the first direction D1 and has the air inlet port 10. The second flow path body 82 is coupled to an upstream end section 13 of the first flow path body 81 in the transport direction F, extends in the second direction D2, and has the air outlet port 11. The internal space of the second flow path body 82 is coupled to the upstream end section 13 of the first flow path body 81 at a portion facing the transport path 3. By this, the air flowing in from the air inlet port 10 flows in the direction K and flows out from the air outlet port 11 to the outside.

The heater 9 is arranged in a portion facing both the first flow path body 81 and the second flow path body 82. In other words, the heater 9 is arranged within the range of the length of the second flow path body 82 in the Y-axis direction. Here, two heaters 9 are installed along the transport path 3.

A cover 20 (shown in FIG. 3) constituting a part of the outer appearance of the heating section 6 is arranged at a lower end section of the first flow path body 81.

### Fan and Wall Section

In the present embodiment, the fan 12 is arranged in a region inside the second flow path body 82 and inside the first flow path body 81. As shown in FIG. 3, the direction Fa in which the fan 12 sends the air is different from the blowing direction Fb in which the air is blown from the air outlet port 11.

Therefore, in the present embodiment, a wall section 15 is arranged in the region between the fan 12 and the air outlet port 11. Specifically, the wall section 15 is a U-shaped plate member installed on the upper surface of the fan 12 and is installed such that an open side of the U-shape is directed toward the air outlet port 11. As indicated by an arrow A, the wall section 15 is configured to guide a direction Fa in which the fan 12 sends air toward a position where the air outlet port 11 is arranged.

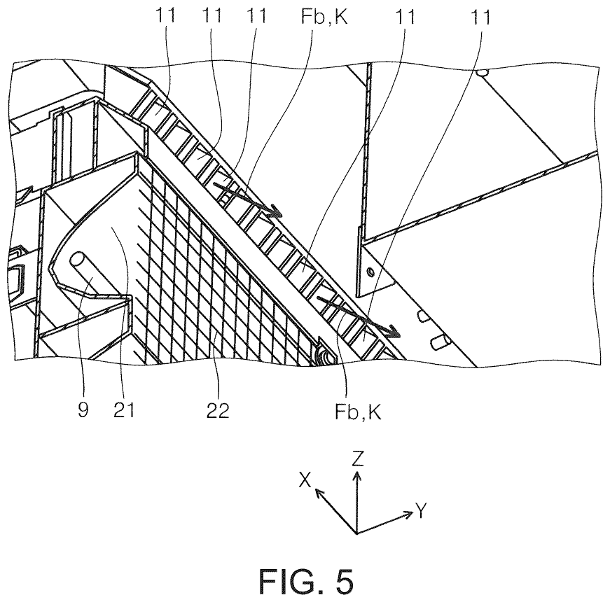

As shown in FIG. 5, in the present embodiment, plural air outlet ports 11 are arranged in the width direction (X-axis direction) of the transport path.

### Air Inlet Port

As shown in FIG. 3, in the present embodiment, the air inlet port 10 is arranged at the position of an end section 14 that is on the opposite side of the first flow path body 81 than the second flow path body 82. In other words, the air inlet port 10 is arranged at a portion farthest from the fan 12. With this arrangement, the air sucked in from the air inlet port 10 by the suction force of the fan 12 flows in the first flow path body 81 over the entire length in the vertical direction (+Z direction) and reaches the fan 12.

As shown in FIG. 1, the air inlet port 10 is positioned on the front side of the recording device 1, and three air inlet ports 10 are arranged in the width direction (X-axis direction). Of course, the number is not limited to three, and may be two or four or more. Although not shown in the drawings, the air inlet port 10 is formed of a mesh body or a lattice body having small openings. The winding section 32 is also positioned on the front side of the recording device 1. In FIG. 1, only the winding shaft 36 of the winding section 32 is shown, and the roll body R2 is not shown.

### Modification

In the above description, the air inlet port 10 is arranged at the position of the end section 14 on the opposite side of the first flow path body 81 than the second flow path body 81. However, the air inlet port 10 is not limited to this position. For example, it may be arranged at a position that is an end face in the −Z direction of the first flow path body 81, that is, at a lower end face, and that is separated from the transport path 3.

### DESCRIPTION OF EFFECTS OF FIRST EMBODIMENT

1: In the present embodiment, the air inlet port 10 is provided at a position that is at the opposite side of the air flow path body 8 than the side facing the medium 2 with respect to the second direction D2 intersecting with the first direction D1. By this, although the downstream transport path member 7, such as the guide bar 34 or the roll body R2, is arranged at a position downstream of the heating section 6 in the transport direction F, the air inlet port 10 is positioned separated from the downstream transport path member 7. In other words, the air inlet port 10 can take fresh air into the inside of the air flow path body 8 from a separate space that is separated from the space where heated air stagnating in the vicinity of the downstream transport path member 7 exists. Therefore, it is possible to suppress a decrease in the drying properties of the medium 2. Further, the temperature rise of the surface of the air flow path body 8 can be suppressed.
2: In the present embodiment, the heater 9 is arranged in a portion that faces both the first flow path body 81 and the second flow path body 82. In other words, the heating section 6, which is constituted by the heater 9 and the air flow path body 8, is positioned such that the heater 9 and the second flow path body 82 overlap each other when viewed from the first direction D1 side. By this, it is possible to suppress an increase in the thickness of the heating section 6 as a whole.
3: In the present embodiment, the fan 12 is arranged in a region inside the second flow path body 82 and inside the first flow path body 81. In other words, the fan 12 is arranged across both regions of the first flow path body 81 and the second flow path body 82. By this, even when the fan 12 has a size that cannot be arranged inside the first flow path body 81, a part of the fan 12 is arranged in the region of the second flow path body 82, and thus it is possible to suppress an increase in size of the entire heating section 9.
4: Further, in the present embodiment, the air inlet port 10 is arranged at the position of the end section of the first flow path body 81 on the opposite side of the second flow path body 82. By this, external fresh air is sucked in through the air inlet port 10 located at the above-mentioned position, flows through the entire length of the first flow path body 81, and reaches the inside of the second flow path body 82. Then, the air flows through the second flow path body 82 and is blown out from the air outlet port 11. Therefore, since the first flow path body 81 and the second flow path body 82 are brought into contact with the external fresh air, it is possible to efficiently suppress the temperature rise of the entire surface of the air flow path body 8.

Since a large distance can be secured between the air inlet port 10 and the fan 12, it is possible to reduce a suction loss due to large bending of a portion serving as a suction portion of external air.
5: In the present embodiment, the wall section 15 is arranged between the fan 12 and the air outlet port 11, and, as indicated by the arrow A, the wall section 15 guides the direction FA of the air sent from the fan 12 toward the position where the air outlet port 11 is located. By this, even if the direction Fa in which the fan 12 sends air and the direction Fb in which air is blown out from the air outlet port 11 are different from each other, the air sent out from the fan 12 first hits the wall section 15, so that the air can be guided by the wall section 15 to the air outlet port 11 while spreading in the width direction (X-axis direction) intersecting with the transport direction.
6: In the present embodiment, since the air outlet ports 11 are arranged in the width direction (X-axis direction) of the transport path 3, it is possible to blow out air uniformly in the width direction (X-axis direction).
7: In the present embodiment, since the first direction D1 is the vertical direction, it is possible to suppress the size of the recording device 1 in the front-rear direction.

### Other Embodiments

The recording device 1 according to the present disclosure basically has the configuration of the embodiment described above, but it is of course possible to change or omit parts of the configuration without departing from the gist of the disclosure of the present application.

What is claimed is:

1. A recording device comprising:
a transport section configured to transport a medium in a transport direction of a transport path;
a recording section that records an image on the medium transported by the transport section;
a heating section that heats the medium that was recorded on and that is transported in a first direction in the transport direction, and
a downstream transport path member that constitutes the transport path at a position downstream of the heating section in the transport direction, wherein
the downstream transport path member is disposed at a position overlapping the heating section in a plan view from the first direction,
the heating section includes
an air flow path body,
a heater that is arranged outside the air flow path body and that is configured to heat the medium,
an air inlet port for sucking air from outside the air flow path body into the interior of the air flow path body,
an air outlet port for blowing out air that is inside the air flow path body toward the medium,
which is outside the air flow path body, and
a fan that is arranged inside the air flow path body and that sends air from the air inlet port to the air outlet port, and
the air inlet port is provided at a location of the air flow path body that is, with respect to a second direction intersecting the first direction, on a side opposite to a side facing the medium transported in the first direction.

2. The recording device according to claim 1 wherein
the air flow path body includes
a first flow path body extending along the first direction and
a second flow path body that is coupled to an upstream end section of the first flow path body in the transport direction, that extends in the second direction, and that includes the air outlet port and
the heater is arranged at a portion facing both the first flow path body and the second flow path body.

3. The recording device according to claim 2 wherein
the fan is arranged in a region inside the second flow path body and also within the first flow path body.

4. The recording device according to claim 2 wherein
the air inlet port is arranged at a position of an end section of the first flow path body on the opposite side of the second flow path body.

5. The recording device according to claim 3 wherein
the direction in which the fan sends air is different from the direction in which air is blown out from the air outlet port,
a wall section is arranged between the fan and the air outlet port, and
the wall section guides the direction of air sent from the fan toward the position at which the air outlet port is arranged.

6. The recording device according to claim 5 wherein
plural air outlet ports are arranged in a width direction intersecting the transport direction of the transport path.

7. The recording device according to claim 1 wherein
the first direction is a vertical direction.
